(19) United States
(12) Patent Application Publication
(10) Pub. No.: US 2025/0307686 A1
(43) Pub. Date: Oct. 2, 2025

(54) ENABLING A MACHINE LEARNING MODEL TO RUN PREDICTIONS ON DOMAINS WHERE TRAINING DATA IS LIMITED BY PERFORMING KNOWLEDGE DISTILLATION FROM FEATURES

(71) Applicant: International Business Machines Corporation, Armonk, NY (US)

(72) Inventors: Michele Merler, New York City, NY (US); Carla Paola Agurto Rios, Ossining, NY (US); Raquel Norel, Bronx, NY (US); Guillermo Cecchi, New York City, NY (US)

(21) Appl. No.: 18/616,498

(22) Filed: Mar. 26, 2024

(51) Int. Cl. G06N 20/00

(52) U.S. Cl. CPC G06N 20/00

(57) ABSTRACT

A computer-implemented method, system, and computer program product for enabling a machine learning model to run predictions on domains where training data is limited. A set of low-level features is selected based on their correlation with the expert knowledge of a domain where training data is limited. Low-level features refer to the more specific individual components of a systematic operation, focusing on the details of rudimentary micro functions rather than macro, complex processes. Correlation refers to a relationship or connection between the features of the low-level features and the features of the expert knowledge of the domain. A student machine learning model is then trained to have its intermediate feature representations mimic the selected set of low-level features. In this manner, machine learning models may be effectively trained to find patterns or make decisions based on data from domains where training data is limited.

### TECHNICAL FIELD

The present disclosure relates generally to machine learning techniques, and more particularly to enabling a machine learning model to run predictions on domains where training data is limited by performing knowledge distillation from domain expertise aligned with low-level features.

### BACKGROUND

Machine learning is a field of study in artificial intelligence concerned with the development and study of statistical algorithms that can learn from data and generalize to unseen data, and thus perform tasks without explicit instructions.

### SUMMARY

In one embodiment of the present disclosure, a computer-implemented method for enabling a machine learning model to run predictions on domains where training data is limited comprises selecting a set of low-level features based on their correlation with expert knowledge of a domain. The method further comprises training a student machine learning model to have its intermediate feature representations mimic the set of low-level features.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the expert feature distillation system to enable a machine learning model to run predictions on domains where training data is limited in accordance with an embodiment of the present disclosure;

FIG. 3 illustrates an embodiment of the present disclosure of the hardware configuration of the expert feature distillation system which is representative of a hardware environment for practicing the present disclosure; and

FIG. 4 is a flowchart of a method for enabling a machine learning model to run predictions on domains where training data is limited in accordance with an embodiment of the present disclosure.

### DETAILED DESCRIPTION

As stated above, machine learning is a field of study in artificial intelligence concerned with the development and study of statistical algorithms that can learn from data and generalize to unseen data, and thus perform tasks without explicit instructions.

Machine learning approaches have been applied to many fields including large language models, computer vision, speech recognition, email filtering, agriculture, and medicine, where it is too costly to develop algorithms to perform the needed tasks. Machine learning is known in its application across business problems under the name predictive analytics. Although not all machine learning is statistically based, computational statistics is an important source of the field's methods.

Recently, deep learning (a type of machine learning based on artificial neural networks in which multiple layers of processing are used to extract progressively higher level features from data) and large language models (language model is notable for its ability to achieve general-purpose language generation and understanding) have demonstrated super human abilities for classification tasks ranging from image understanding to medical test completion. To achieve such high levels of performance, these powerful systems require vast quantities of training data.

Unfortunately, vast quantities of training data are not available in many domains. A domain is the knowledge of a specific discipline or field. As a result, machine learning techniques have been developed to deal with data scarcity in a given domain, such as few-shot learning, transfer learning, domain adaptation, and knowledge distillation. While powerful, such techniques rely on the existence of either high performing general models to either learn from or adapt or large training data in domains that are somehow related to the target domain. However, this is unrealistic in certain domains due to data scarcity and the specificity of the domain.

As a result, there is not currently a means for enabling a machine learning model to run predictions on certain domains where training data is limited with high levels of accuracy.

The embodiments of the present disclosure provide a means for enabling a machine learning model to run predictions on domains where training data is limited by performing knowledge distillation from domain expertise aligned with low-level features. In one embodiment, a new knowledge distillation framework is utilized for deriving domain specific knowledge from low-level features that are aligned with expert knowledge of a domain (e.g., aligned in the common feature space). A domain, as used herein, refers to the knowledge of a specific discipline or field (e.g., amyotrophic lateral sclerosis, Parkinson's disease). Expert knowledge of a domain, as used herein, refers to human in-depth knowledge and understanding of a specific discipline or field. It encompasses not only familiarity with relevant data sources and terminology but also an appreciation for the nuances, challenges, and context that are unique to that domain. Low-level features, as used herein, refer to the more specific individual components of a systematic operation, focusing on the details of rudimentary micro functions rather than macro, complex processes. Low-level classification is typically more concerned with individual components within the system and how they operate. High-level features, as used herein, describe those operations that are more abstract and general in nature, where the high-level features are typically more concerned with the wider, macro system as a whole. In one embodiment, low-level features may be pre-established, such as by an expert, where a set of low-level features from the pre-established low-level features is selected based on their alignment with the expert knowledge for the domain where training data is limited. Such an alignment may involve identifying the low-level features that share the same feature space as the features of the expert knowledge of the domain. In one embodiment, the low-level features are aligned with the expert knowledge for the domain by extracting features from the domain expertise, such as by using a statistical method (e.g., term frequency-inverse document frequency) for identifying the important terms from the expert knowledge, and then identifying a set of low-level features that overlap the extracted features from the domain expertise, such as by utilizing a common feature extraction technique (e.g., CoMut, common-specific feature learning). Afterwards, a machine learning student model is trained to have its intermediate feature representations mimic the set of low-level features that are aligned with the domain expertise. In this manner, such a knowledge distillation framework does not require a large amount of training data. As a result, a machine learning model is able to run predictions on domains where training data is limited. A further discussion regarding these and other features is provided below.

In some embodiments of the present disclosure, the present disclosure comprises a computer-implemented method, system, and computer program product for enabling a machine learning model to run predictions on domains where training data is limited. In one embodiment of the present disclosure, a set of low-level features is selected based on their correlation with the expert knowledge of a domain where training data is limited. Low-level features, as used herein, refer to the more specific individual components of a systematic operation, focusing on the details of rudimentary micro functions rather than macro, complex processes. Low-level classification is typically more concerned with individual components within the system and how they operate. Correlation, as used herein, refers to a relationship or connection between the features of the low-level features and the features of the expert knowledge of the domain. In one embodiment, such a selection of the set of low-level features based on their correlation with the expert knowledge of the domain corresponds to aligning such low-level features with the expert knowledge of the domain. In one embodiment, such an alignment is performed based on feature mapping. Furthermore, a student machine learning model is trained to have its intermediate feature representations mimic the selected set of low-level features. “Intermediate feature representations,” as used herein, refer to representations of the inputs (inputs to the student machine learning model) that model the presence or absence of particular features (features corresponding to the selected low-level features) in the intermediate layers of the student machine learning model, which may correspond to a deep learning architecture (e.g., convolutional neural network, deep neural network, recurrent neural network, etc.). In this manner, machine learning models may be effectively trained to find patterns or make decisions based on data from domains where training data is limited.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

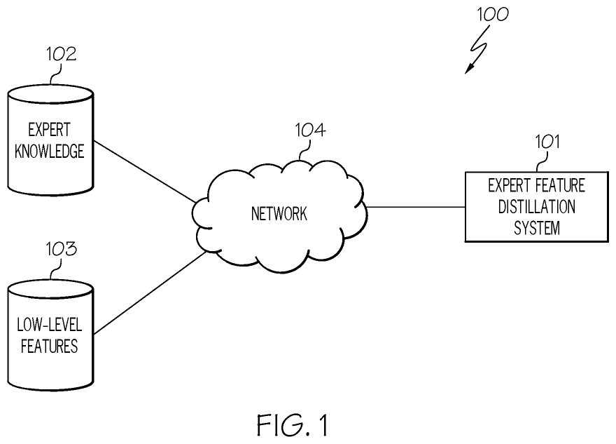

Referring now to the Figures in detail, FIG. 1 illustrates an embodiment of the present disclosure of a communication system 100 for practicing the principles of the present disclosure. Communication system 100 includes an expert feature distillation system 101 connected to databases 102, 103 storing expert knowledge of a domain and low-level features, respectively, via a network 104.

A domain, as used herein, refers to the knowledge of a specific discipline or field (e.g., amyotrophic lateral sclerosis, Parkinson's disease). Expert knowledge of a domain, as used herein, such as the expert knowledge of a domain stored in database 102, refers to human in-depth knowledge and understanding of a specific discipline or field. It encompasses not only familiarity with relevant data sources and terminology but also an appreciation for the nuances, challenges, and context that are unique to that domain. In one embodiment, such expert knowledge stored in database 102 is utilized by the present disclosure for domains where training data is limited.

Low-level features, as used herein, such as the low-level features stored in database 103, refer to the more specific individual components of a systematic operation, focusing on the details of rudimentary micro functions rather than macro, complex processes. Low-level classification is typically more concerned with individual components within the system and how they operate. High-level features, as used herein, describe those operations that are more abstract and general in nature, where the high-level features are typically more concerned with the wider, macro system as a whole. In one embodiment, the low-level features stored in database 103 are pre-established, such as by an expert.

In one embodiment, expert feature distillation system 101 is configured to implement a new knowledge distillation framework that derives domain specific knowledge from low-level features that are aligned with expert knowledge of a domain (e.g., medical field, drug discovery, cybersecurity, etc.) as opposed to utilizing a large teacher model. Such an alignment, as used herein, refers to selecting a set of low-level features from the low-level features stored in database 103 based on their correlation with expert knowledge of a domain stored in database 102. Correlation, as used herein, refers to a relationship or connection between the features of the low-level features stored in database 103 and the features of the expert knowledge of the domain stored in database 102.

In one embodiment, such an alignment is performed by expert feature distillation system 101 by identifying the low-level features that share the same feature space as the features of the expert knowledge of the domain.

In one embodiment, expert feature distillation system 101 selects a set of low-level features from the low-level features stored in database 103 based on their correlation with expert knowledge of a domain stored in database 102 based on feature mapping. For example, in amyotrophic lateral sclerosis and Parkison's disease assessment and monitoring, speech rate (low-level features) has been shown to be correlated with expert diagnosis.

In one embodiment, expert feature distillation system 101 trains a student machine learning model to have its intermediate feature representations mimic the selected set of low-level features. “Intermediate feature representations,” as used herein, refer to the representations of the inputs (inputs to the student machine learning model) that model the presence or absence of particular features (features corresponding to the selected low-level features) in the intermediate layers of the student machine learning model, which may correspond to a deep learning architecture (e.g., convolutional neural network, deep neural network, recurrent neural network, etc.). In this new knowledge distillation framework, the “teacher” model corresponds to the expert knowledge of the domain stored in database 102.

In one embodiment, expert feature distillation system 101 trains a student machine learning model to have its intermediate feature representations mimic the selected set of low-level features using supervised learning.

In one embodiment, the intermediate feature representations and the selected set of low-level features are multi-dimensional vectors.

In one embodiment, during the training of the student machine learning model to have its intermediate feature representations mimic the selected set of low-level features using supervised learning, the difference between the student machine learning model's predicted and actual output is computed. Such a difference is referred to herein as the matching or classification loss which is minimized during the training of the student machine learning model. After minimizing such a loss, the trained student machine learning model is deemed to have achieved the desired accuracy.

In one embodiment, expert feature distillation system 101 generates predictions on the domain (e.g., medical field, drug discovery, cybersecurity, etc.) where training data is limited using the trained student machine learning model after the predictions of the student machine learning model have achieved the desired accuracy.

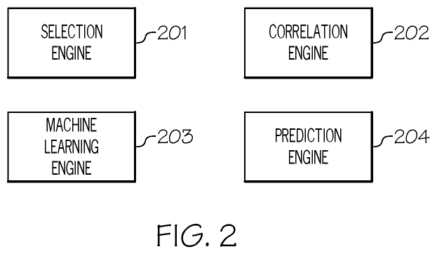

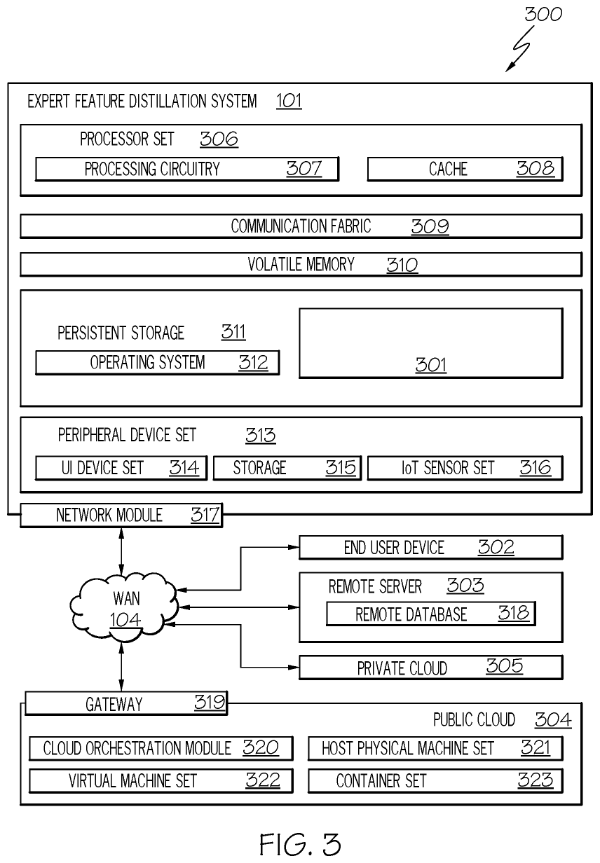

A description of the software components of expert feature distillation system 101 used for enabling a machine learning model to run predictions on domains where training data is limited is provided below in connection with FIG. 2. A description of the hardware configuration of expert feature distillation system 101 is provided further below in connection with FIG. 3.

Referring again to FIG. 1, network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of expert feature distillation systems 101, databases 102, 103, and networks 104.

A discussion regarding the software components used by expert feature distillation system 101 to enable a machine learning model to run predictions on domains where training data is limited is provided below in connection with FIG. 2.

FIG. 2 is a diagram of the software components used by expert feature distillation system 101 to enable a machine learning model to run predictions on domains where training data is limited in accordance with an embodiment of the present disclosure.

Referring to FIG. 2, in conjunction with FIG. 1, expert feature distillation system 101 includes selection engine 201 configured to select a domain where training data is limited or scarce. As discussed above, a domain, as used herein, refers to the knowledge of a specific discipline or field (e.g., amyotrophic lateral sclerosis, Parkinson's disease). Certain domains may not have a large quantity of training data. In one embodiment, an empirical analysis is used to determine if a domain does not have the necessary quantity of training data. For example, if the set of training data for a domain does not contain 5,000 samples per class, then the domain is deemed to have a limited amount of training data. In another example, if the number of examples in the training data for a domain is not ten times more than the number of degrees of freedom the model has, then the domain is deemed to have a limited amount of training data. Based on such an empirical analysis, selection engine 201 selects a domain where training data is limited.

Furthermore, in one embodiment, selection engine 201 identifies a source of expert knowledge of the selected domain, which resides in database 102. As discussed above, expert knowledge of a domain, as used herein, such as the expert knowledge of a domain stored in database 102, refers to human in-depth knowledge and understanding of a specific discipline or field. It encompasses not only familiarity with relevant data sources and terminology but also an appreciation for the nuances, challenges, and context that are unique to that domain. In one embodiment, such expert knowledge stored in database 102 is utilized by the present disclosure for domains where training data is limited.

Examples of expert knowledge include knowledge from medical experts, such as in the domain of amyotrophic lateral sclerosis and Parkinson's disease. In one embodiment, such expert knowledge is acquired by an expert and stored in database 102.

Expert feature distillation system 101 further includes correlation engine 202 which is configured to select a set of low-level features from the low-level features stored in database 103 based on their correlation with the expert knowledge of the domain selected by selection engine 201. As stated above, low-level features, as used herein, such as the low-level features stored in database 103, refer to the more specific individual components of a systematic operation, focusing on the details of rudimentary micro functions rather than macro, complex processes. Low-level classification is typically more concerned with individual components within the system and how they operate. High-level features, as used herein, describe those operations that are more abstract and general in nature, where the high-level features are typically more concerned with the wider, macro system as a whole. In one embodiment, the low-level features stored in database 103 are pre-established, such as by an expert.

As discussed above, correlation engine 202 selects a set of low-level features from the low-level features stored in database 103 based on their correlation with the expert knowledge of the domain selected by selection engine 201. Correlation, as used herein, refers to a relationship or connection between the features of the low-level features stored in database 103 and the features of the expert knowledge of the domain stored in database 102. In one embodiment, such a selection of the set of low-level features from the low-level features stored in database 103 based on their correlation with the expert knowledge of the domain corresponds to aligning such low-level features with the expert knowledge of the domain.

In one embodiment, such an alignment is performed by correlation engine 202 by identifying the low-level features that share the same feature space as the features of the expert knowledge of the domain. In one embodiment, the low-level features are aligned with the expert knowledge for the domain by extracting features from the domain expertise stored in database 102, such as by using a statistical method (e.g., term frequency-inverse document frequency) for identifying the important terms from the expert knowledge, and then identifying a set of low-level features from the low-level features of database 103 that overlap the extracted features from the domain expertise, such as by utilizing a common feature extraction technique (e.g., CoMut, common-specific feature learning).

In one embodiment, correlation engine 202 extracts features from the expert knowledge of the domain stored in database 102 using the sklearn.feature.extraction module from the sckit-learn® machine learning library.

In another embodiment, correlation engine 202 extracts features from the expert knowledge of the domain stored in database 102 using other feature extraction techniques, such as extracting embeddings from a transformer model, histograms, etc. In one embodiment, correlation engine 202 extracts features from the expert knowledge of the domain stored in database 102 using a statistical method, such as term frequency-inverse document frequency.

In one embodiment, correlation engine 202 selects a set of low-level features from the low-level features stored in database 103 based on their correlation with the expert knowledge of a domain stored in database 102 based on feature mapping. For example, in amyotrophic lateral sclerosis and Parkison's disease assessment and monitoring, speech rate has been shown to be correlated with expert diagnosis. In one embodiment, feature mapping is used to align the low-level features stored in database 103 with the expert knowledge of the domain stored in database 102 by matching the features of the low-level features (e.g., speech rate) stored in database 103 with the features of the expert knowledge of the domain stored in database 102. In one embodiment, such feature mapping may correspond to identifying a set of low-level features from the low-level features of database 103 that overlap the extracted features from the domain expertise, such as by utilizing a common feature extraction technique (e.g., CoMut, common-specific feature learning).

In one embodiment, correlation engine 202 uses a common feature extraction technique, such as common-specific feature learning, to explore a subspace where the combination of common and specific features from the low-level features of database 103 and the expert knowledge of the domain stored in database 102 makes learned representations comprehensive. In one embodiment, correlation engine 202 seeks a domain-invariant mapping to extract the information shared by the low-level features of database 103 and the expert knowledge of the domain stored in database 102. Such shared information then forms the selected set of low-level features that are aligned with the expert knowledge of the domain stored in database 102.

Expert feature distillation system 101 further includes a machine learning engine 203 configured to train a student machine learning model to have its intermediate feature representations mimic the selected set of low-level features. In this new knowledge distillation framework, the “teacher” model corresponds to the expert knowledge of the domain stored in database 102. As a result, this new knowledge distillation framework does not require a large amount of training data.

As discussed above, in one embodiment, machine learning engine 203 trains a student machine learning model to have its intermediate feature representations mimic the selected set of low-level features, such as by using supervised learning. “Intermediate feature representations,” as used herein, refer to representations of the inputs (inputs to the student machine learning model) that model the presence or absence of particular features corresponding to the selected low-level features in the intermediate layers of the student machine learning model, which may correspond to a deep learning architecture (e.g., convolutional neural network, deep neural network, recurrent neural network, etc.).

In one embodiment, the intermediate feature representations and the selected set of low-level features are multi-dimensional vectors.

In one embodiment, machine learning engine 203 is configured to build and train a student learning machine learning model to predict the low-level features of a domain where training data is limited. For example, the student learning machine learning model is trained to predict the low-level features of a domain where training data is limited by having its intermediate feature representations mimic the selected set of low-level features.

In one embodiment, the machine learning model is trained to predict the low-level features of a domain where training data is limited based on a sample data set that includes the selected set of low-level features. Such a sample data set may be stored in a data structure (e.g., table) residing within the storage device of expert feature distillation system 101.

Furthermore, in one embodiment, the sample data set discussed above is referred to herein as the “training data,” which is used by a machine learning algorithm to make predictions as to the low-level features of a domain where training data is limited. The algorithm iteratively makes predictions on the training data as to the predicted low-level features of a domain where training data is limited until the predictions achieve the desired accuracy as determined by an expert. Examples of such machine learning algorithms include nearest neighbor, Naïve Bayes, decision trees, linear regression, support vector machines, and neural networks.

In one embodiment, during the training of the student machine learning model to have its intermediate feature representations mimic the selected set of low-level features, such as by using supervised learning, machine learning engine 203 computes the difference between the student machine learning model's predicted and actual output. Such a difference is referred to herein as the matching or classification loss.

In one embodiment, machine learning engine 203 calculates such a loss by computing the distance between the intermediate feature representations and the selected set of low-level features. In one embodiment, such a distance corresponds to the cosine distance. Cosine distance=1−cosine similarity, where cosine similarity is a metric that determines how two vectors (intermediate feature representations and the selected set of low-level features are in vector format) are similar to each other. “Cosine similarity,” as used herein, refers to a measure of similarity between two non-zero vectors defined in an inner product space. Cosine similarity is the cosine of the angle between the vectors.

In one embodiment, such a calculated loss corresponds to a classification loss, a mean squared error, a Kullback-Leibler divergence loss, a regression, a cross entropy loss, etc.

Expert feature distillation system 101 further includes prediction engine 204 configured to generate predictions on the domain where training data is limited using the trained student machine learning model after the predictions of the student machine learning model have achieved the desired accuracy as determined by an expert.

For example, prediction engine 204 may utilize the trained student machine learning model to find patterns or make decisions, such as predicting the low-level features of a domain (e.g., medical field, drug discovery, cybersecurity, etc.), where training data is limited, based on inputting to the trained student machine learning model the expert knowledge of the domain, such as the features of the expert knowledge of the domain where training data is limited.

In this manner, machine learning models may be effectively trained to find patterns or make decisions based on data from domains where training data is limited.

A further description of these and other features is provided below in connection with the discussion of the method for enabling a machine learning model to run predictions on domains where training data is limited.

Prior to the discussion of the method for enabling a machine learning model to run predictions on domains where training data is limited, a description of the hardware configuration of expert feature distillation system 101 (FIG. 1) is provided below in connection with FIG. 3.

Referring now to FIG. 3, in conjunction with FIG. 1, FIG. 3 illustrates an embodiment of the present disclosure of the hardware configuration of expert feature distillation system 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code which is stored in block 301 involved in performing the disclosed methods, such as enabling a machine learning model to run predictions on domains where training data is limited. In addition to block 301, computing environment 300 includes, for example, expert feature distillation system 101, network 104, such as a wide area network (WAN), end user device (EUD) 302, remote server 303, public cloud 304, and private cloud 305. In this embodiment, expert feature distillation system 101 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Expert feature distillation system 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically expert feature distillation system 101, to keep the presentation as simple as possible. Expert feature distillation system 101 may be located in a cloud, even though it is not shown in a cloud in FIG. 3. On the other hand, expert feature distillation system 101 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto expert feature distillation system 101 to cause a series of operational steps to be performed by processor set 306 of expert feature distillation system 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of expert feature distillation system 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In expert feature distillation system 101, the volatile memory 310 is located in a single package and is internal to expert feature distillation system 101, but, alternatively or additionally, the volatile memory may be distributed over multiple packages and/or located externally with respect to expert feature distillation system 101.

Persistent Storage 311 is any form of non-volatile storage for computers that is now known or to be developed in the future. The non-volatility of this storage means that the stored data is maintained regardless of whether power is being supplied to expert feature distillation system 101 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of expert feature distillation system 101. Data communication connections between the peripheral devices and the other components of expert feature distillation system 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where expert feature distillation system 101 is required to have a large amount of storage (for example, where expert feature distillation system 101 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows expert feature distillation system 101 to communicate with other computers through WAN 104. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to expert feature distillation system 101 from an external computer or external storage device through a network adapter card or network interface included in network module 317.

WAN 104 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates expert feature distillation system 101), and may take any of the forms discussed above in connection with expert feature distillation system 101. EUD 302 typically receives helpful and useful data from the operations of expert feature distillation system 101. For example, in a hypothetical case where expert feature distillation system 101 is designed to provide a recommendation to an end user, this recommendation would typically be communicated from network module 317 of expert feature distillation system 101 through WAN 104 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to expert feature distillation system 101. Remote server 303 may be controlled and used by the same entity that operates expert feature distillation system 101. Remote server 303 represents the machine(s) that collect and store helpful and useful data for use by other computers, such as expert feature distillation system 101. For example, in a hypothetical case where expert feature distillation system 101 is designed and programmed to provide a recommendation based on historical data, then this historical data may be provided to expert feature distillation system 101 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 104 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to enable a machine learning model to run predictions on domains where training data is limited. In one embodiment, such components may be implemented in hardware. The functions discussed above performed by such components are not generic computer functions. As a result, expert feature distillation system 101 is a particular machine that is the result of implementing specific, non-generic computer functions.

In one embodiment, the functionality of such software components of expert feature distillation system 101, including the functionality for enabling a machine learning model to run predictions on domains where training data is limited, may be embodied in an application specific integrated circuit.

As stated above, machine learning approaches have been applied to many fields including large language models, computer vision, speech recognition, email filtering, agriculture, and medicine, where it is too costly to develop algorithms to perform the needed tasks. Machine learning is known in its application across business problems under the name predictive analytics. Although not all machine learning is statistically based, computational statistics is an important source of the field's methods. Recently, deep learning (a type of machine learning based on artificial neural networks in which multiple layers of processing are used to extract progressively higher level features from data) and large language models (language model is notable for its ability to achieve general-purpose language generation and understanding) have demonstrated super human abilities for classification tasks ranging from image understanding to medical test completion. To achieve such high levels of performance, these powerful systems require vast quantities of training data. Unfortunately, vast quantities of training data are not available in many domains. A domain is the knowledge of a specific discipline or field. As a result, machine learning techniques have been developed to deal with data scarcity in a given domain, such as few-shot learning, transfer learning, domain adaptation, and knowledge distillation. While powerful, such techniques rely on the existence of either high performing general models to either learn from or adapt or large training data in domains that are somehow related to the target domain. However, this is unrealistic in certain domains due to data scarcity and the specificity of the domain. As a result, there is not currently a means for enabling a machine learning model to run predictions on certain domains where training data is limited with high levels of accuracy.

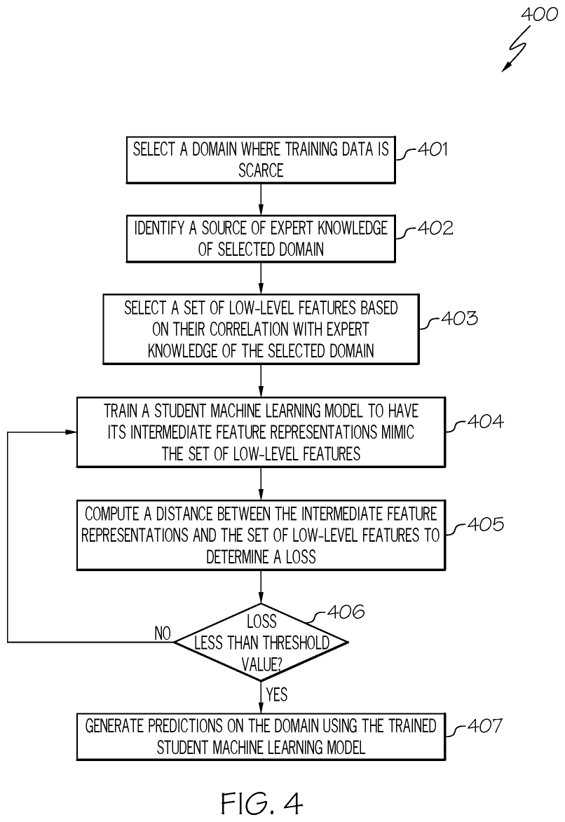

The embodiments of the present disclosure provide a means for enabling a machine learning model to run predictions on domains where training data is limited by performing knowledge distillation from domain expertise aligned with low-level features as discussed below in connection with FIG. 4.

FIG. 4 is a flowchart of a method 400 for enabling a machine learning model to run predictions on domains where training data is limited in accordance with an embodiment of the present disclosure.

Referring to FIG. 4, in conjunction with FIGS. 1-3, in step 401, selection engine 201 of expert feature distillation system 101 selects a domain where training data is limited or scarce.

As discussed above, a domain, as used herein, refers to the knowledge of a specific discipline or field (e.g., amyotrophic lateral sclerosis, Parkinson's disease). Certain domains may not have a large quantity of training data. In one embodiment, an empirical analysis is used to determine if a domain does not have the necessary quantity of training data. For example, if the set of training data for a domain does not contain 5,000 samples per class, then the domain is deemed to have a limited amount of training data. In another example, if the number of examples in the training data for a domain is not ten times more than the number of degrees of freedom the model has, then the domain is deemed to have a limited amount of training data. Based on such an empirical analysis, selection engine 201 selects a domain where training data is limited.

In step 402, selection engine 201 of expert feature distillation system 101 identifies a source of expert knowledge of the selected domain, which resides in database 102.

As stated above, expert knowledge of a domain, as used herein, such as the expert knowledge of a domain stored in database 102, refers to human in-depth knowledge and understanding of a specific discipline or field. It encompasses not only familiarity with relevant data sources and terminology but also an appreciation for the nuances, challenges, and context that are unique to that domain. In one embodiment, such expert knowledge stored in database 102 is utilized by the present disclosure for domains where training data is limited.

Examples of expert knowledge include knowledge from medical experts, such as in the domain of amyotrophic lateral sclerosis and Parkinson's disease. In one embodiment, such expert knowledge is acquired by an expert and stored in database 102.

In step 403, correlation engine 202 of expert feature distillation system 101 selects a set of low-level features from the low-level features stored in database 103 based on their correlation with the expert knowledge of the domain selected by selection engine 201.

As discussed above, low-level features, as used herein, such as the low-level features stored in database 103, refer to the more specific individual components of a systematic operation, focusing on the details of rudimentary micro functions rather than macro, complex processes. Low-level classification is typically more concerned with individual components within the system and how they operate. High-level features, as used herein, describe those operations that are more abstract and general in nature, where the high-level features are typically more concerned with the wider, macro system as a whole. In one embodiment, the low-level features stored in database 103 are pre-established, such as by an expert.

As also discussed above, correlation engine 202 selects a set of low-level features from the low-level features stored in database 103 based on their correlation with the expert knowledge of the domain selected by selection engine 201. Correlation, as used herein, refers to a relationship or connection between the features of the low-level features stored in database 103 and the features of the expert knowledge of the domain stored in database 102. In one embodiment, such a selection of the set of low-level features from the low-level features stored in database 103 based on their correlation with the expert knowledge of the domain corresponds to aligning such low-level features with the expert knowledge of the domain.

In one embodiment, such an alignment is performed by correlation engine 202 by identifying the low-level features that share the same feature space as the features of the expert knowledge of the domain. In one embodiment, the low-level features are aligned with the expert knowledge for the domain by extracting features from the domain expertise stored in database 102, such as by using a statistical method (e.g., term frequency-inverse document frequency) for identifying the important terms from the expert knowledge, and then identifying a set of low-level features from the low-level features of database 103 that overlap the extracted features from the domain expertise, such as by utilizing a common feature extraction technique (e.g., CoMut, common-specific feature learning).

In one embodiment, correlation engine 202 extracts features from the expert knowledge of the domain stored in database 102 using the sklearn.feature.extraction module from the sckit-learn® machine learning library.

In another embodiment, correlation engine 202 extracts features from the expert knowledge of the domain stored in database 102 using other feature extraction techniques, such as extracting embeddings from a transformer model, histograms, etc. In one embodiment, correlation engine 202 extracts features from the expert knowledge of the domain stored in database 102 using a statistical method, such as term frequency-inverse document frequency.

In one embodiment, correlation engine 202 selects a set of low-level features from the low-level features stored in database 103 based on their correlation with the expert knowledge of a domain stored in database 102 based on feature mapping. For example, in amyotrophic lateral sclerosis and Parkison's disease assessment and monitoring, speech rate has been shown to be correlated with expert diagnosis. In one embodiment, feature mapping is used to align the low-level features stored in database 103 with the expert knowledge of the domain stored in database 102 by matching the features of the low-level features (e.g., speech rate) stored in database 103 with the features of the expert knowledge of the domain stored in database 102. In one embodiment, such feature mapping may correspond to identifying a set of low-level features from the low-level features of database 103 that overlap the extracted features from the domain expertise, such as by utilizing a common feature extraction technique (e.g., CoMut, common-specific feature learning).

In one embodiment, correlation engine 202 uses a common feature extraction technique, such as common-specific feature learning, to explore a subspace where the combination of common and specific features from the low-level features of database 103 and the expert knowledge of the domain stored in database 102 makes learned representations comprehensive. In one embodiment, correlation engine 202 seeks a domain-invariant mapping to extract the information shared by the low-level features of database 103 and the expert knowledge of the domain stored in database 102. Such shared information then forms the selected set of low-level features that are aligned with the expert knowledge of the domain stored in database 102.

In step 404, machine learning engine 203 of expert feature distillation system 101 trains a student machine learning model to have its intermediate feature representations mimic the selected set of low-level features.

As discussed above, in one embodiment, machine learning engine 203 trains a student machine learning model to have its intermediate feature representations mimic the selected set of low-level features, such as by using supervised learning. “Intermediate feature representations,” as used herein, refer to representations of the inputs (inputs to the student machine learning model) that model the presence or absence of particular features (features corresponding to the selected low-level features) in the intermediate layers of the student machine learning model, which may correspond to a deep learning architecture (e.g., convolutional neural network, deep neural network, recurrent neural network, etc.).

In one embodiment, the intermediate feature representations and the selected set of low-level features are multi-dimensional vectors.

In one embodiment, machine learning engine 203 is configured to build and train a student learning machine learning model to predict the low-level features of a domain where training data is limited. For example, the student learning machine learning model is trained to predict the low-level features of a domain where training data is limited by having its intermediate feature representations mimic the selected set of low-level features.

In one embodiment, the machine learning model is trained to predict the low-level features of a domain where training data is limited based on a sample data set that includes the selected set of low-level features. Such a sample data set may be stored in a data structure (e.g., table) residing within the storage device (e.g., storage device 311, 315) of expert feature distillation system 101.

Furthermore, in one embodiment, the sample data set discussed above is referred to herein as the “training data,” which is used by a machine learning algorithm to make predictions as to the low-level features of a domain where training data is limited. The algorithm iteratively makes predictions on the training data as to the predicted low-level features of a domain where training data is limited until the predictions achieve the desired accuracy as determined by an expert. Examples of such machine learning algorithms include nearest neighbor, Naïve Bayes, decision trees, linear regression, support vector machines, and neural networks.

In one embodiment, during the training of the student machine learning model to have its intermediate feature representations mimic the selected set of low-level features, such as by using supervised learning, machine learning engine 203 computes the difference between the student machine learning model's predicted and actual output. Such a difference is referred to herein as the matching or classification loss.

In step 405, machine learning engine 203 of expert feature distillation system 101 computes the distance between the intermediate feature representations and the selected set of low-level features to calculate the loss discussed above.

As stated above, in one embodiment, such a distance corresponds to the cosine distance. Cosine distance=1−cosine similarity, where cosine similarity is a metric that determines how two vectors (intermediate feature representations and the selected set of low-level features are in vector format) are similar to each other. “Cosine similarity,” as used herein, refers to a measure of similarity between two non-zero vectors defined in an inner product space. Cosine similarity is the cosine of the angle between the vectors.

In one embodiment, such a calculated loss corresponds to a classification loss, a mean squared error, a Kullback-Leibler divergence loss, a regression, a cross entropy loss, etc.

In step 406, machine learning engine 203 of expert feature distillation system 101 determines if the calculated loss is less than a threshold value, which may be user-designated. Such a determination is made to determine if the student machine learning model has achieved the desired accuracy.

If the calculated loss is not less than the threshold value (i.e., the student machine learning model has not achieved the desired accuracy), then machine learning engine 203 of expert feature distillation system 101 continues to train the student machine learning model to have its intermediate feature representations mimic the set of low-level features in step 404.

If, however, the calculated loss is less than the threshold value (i.e., the student machine learning model has achieved the desired accuracy), then, in step 407, prediction engine 204 of expert feature distillation system 101 generates predictions on the domain where training data is limited using the trained student machine learning model.

For example, prediction engine 204 may utilize the trained student machine learning model to find patterns or make decisions, such as predicting the low-level features of a domain (e.g., medical field, drug discovery, cybersecurity, etc.), where training data is limited, based on inputting to the trained student machine learning model the expert knowledge of the domain, such as the features of the expert knowledge of the domain where training data is limited.

In this manner, machine learning models may be effectively trained to find patterns or make decisions based on data from domains where training data is limited. That is, machine learning models may be reliably learned even based on domains where training data is limited, where such domains have expert knowledge, such as human expertise.

Furthermore, the principles of the present disclosure improve the technology or technical field involving machine learning techniques.

As discussed above, machine learning approaches have been applied to many fields including large language models, computer vision, speech recognition, email filtering, agriculture, and medicine, where it is too costly to develop algorithms to perform the needed tasks. Machine learning is known in its application across business problems under the name predictive analytics. Although not all machine learning is statistically based, computational statistics is an important source of the field's methods. Recently, deep learning (a type of machine learning based on artificial neural networks in which multiple layers of processing are used to extract progressively higher level features from data) and large language models (language model is notable for its ability to achieve general-purpose language generation and understanding) have demonstrated super human abilities for classification tasks ranging from image understanding to medical test completion. To achieve such high levels of performance, these powerful systems require vast quantities of training data. Unfortunately, vast quantities of training data are not available in many domains. A domain is the knowledge of a specific discipline or field. As a result, machine learning techniques have been developed to deal with data scarcity in a given domain, such as few-shot learning, transfer learning, domain adaptation, and knowledge distillation. While powerful, such techniques rely on the existence of either high performing general models to either learn from or adapt or large training data in domains that are somehow related to the target domain. However, this is unrealistic in certain domains due to data scarcity and the specificity of the domain. As a result, there is not currently a means for enabling a machine learning model to run predictions on certain domains where training data is limited with high levels of accuracy.

Embodiments of the present disclosure improve such technology by selecting a set of low-level features based on their correlation with the expert knowledge of a domain where training data is limited. Low-level features, as used herein, refer to the more specific individual components of a systematic operation, focusing on the details of rudimentary micro functions rather than macro, complex processes. Low-level classification is typically more concerned with individual components within the system and how they operate. Correlation, as used herein, refers to a relationship or connection between the features of the low-level features and the features of the expert knowledge of the domain. In one embodiment, such a selection of the set of low-level features based on their correlation with the expert knowledge of the domain corresponds to aligning such low-level features with the expert knowledge of the domain. In one embodiment, such an alignment is performed based on feature mapping. Furthermore, a student machine learning model is trained to have its intermediate feature representations mimic the selected set of low-level features. “Intermediate feature representations,” as used herein, refer to representations of the inputs (inputs to the student machine learning model) that model the presence or absence of particular features (features corresponding to the selected low-level features) in the intermediate layers of the student machine learning model, which may correspond to a deep learning architecture (e.g., convolutional neural network, deep neural network, recurrent neural network, etc.). In this manner, machine learning models may be effectively trained to find patterns or make decisions based on data from domains where training data is limited. Furthermore, in this manner, there is an improvement in the technical field involving machine learning techniques.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for enabling a machine learning model to run predictions on domains where training data is limited, the method comprising:
selecting a set of low-level features based on their correlation with expert knowledge of a domain; and
training a student machine learning model to have its intermediate feature representations mimic said set of low-level features.

2. The method as recited in claim 1 further comprising:
generating predictions on said domain using said trained student machine learning model.

3. The method as recited in claim 1, the method further comprising:
computing a distance between said intermediate feature representations and said set of low-level features to determine a loss.

4. The method as recited in claim 3, wherein said intermediate feature representations and said set of low-level features are multi-dimensional vectors.

5. The method as recited in claim 3, wherein said distance is a cosine distance.

6. The method as recited in claim 3, wherein said loss is selected from the group consisting of: a classification loss, a mean squared error, a Kullback-Leibler divergence loss, a regression, and a cross entropy loss.

7. The method as recited in claim 1, wherein said student machine learning model is trained in a supervised manner.

8. A computer program product for enabling a machine learning model to run predictions on domains where training data is limited, the computer program product comprising one or more computer readable storage mediums having program code embodied therewith, the program code comprising programming instructions for:
selecting a set of low-level features based on their correlation with expert knowledge of a domain; and
training a student machine learning model to have its intermediate feature representations mimic said set of low-level features.

9. The computer program product as recited in claim 8, wherein the program code further comprises the programming instructions for:
generating predictions on said domain using said trained student machine learning model.

10. The computer program product as recited in claim 8, wherein the program code further comprises the programming instructions for:
computing a distance between said intermediate feature representations and said set of low-level features to determine a loss.

11. The computer program product as recited in claim 10, wherein said intermediate feature representations and said set of low-level features are multi-dimensional vectors.

12. The computer program product as recited in claim 10, wherein said distance is a cosine distance.

13. The computer program product as recited in claim 10, wherein said loss is selected from the group consisting of: a classification loss, a mean squared error, a Kullback-Leibler divergence loss, a regression, and a cross entropy loss.

14. The computer program product as recited in claim 8, wherein said student machine learning model is trained in a supervised manner.

15. A system, comprising:
a memory for storing a computer program for enabling a machine learning model to run predictions on domains where training data is limited; and
a processor connected to the memory, wherein the processor is configured to execute program instructions of the computer program comprising:
selecting a set of low-level features based on their correlation with expert knowledge of a domain; and
training a student machine learning model to have its intermediate feature representations mimic said set of low-level features.

16. The system as recited in claim 15, wherein the program instructions of the computer program further comprise:
generating predictions on said domain using said trained student machine learning model.

17. The system as recited in claim 15, wherein the program instructions of the computer program further comprise:
computing a distance between said intermediate feature representations and said set of low-level features to determine a loss.

18. The system as recited in claim 17, wherein said intermediate feature representations and said set of low-level features are multi-dimensional vectors.

19. The system as recited in claim 17, wherein said distance is a cosine distance.

20. The system as recited in claim 17, wherein said loss is selected from the group consisting of: a classification loss, a mean squared error, a Kullback-Leibler divergence loss, a regression, and a cross entropy loss.
